(19) United States
(12) Patent Application Publication
(10) Pub. No.: US 2014/0123254 A1
(43) Pub. Date: May 1, 2014

(54) WEBSITE RELATIONSHIP AND SHARING ACCOUNT

(71) Applicant: Alpha Sun & Sport - AS&S, LLC, Pompano Beach, FL (US)

(72) Inventor: Alan McBrearty, Boca Raton, FL (US)

(73) Assignee: Alpha Sun & Sport - AS&S, LLC, Pompano Beach, FL (US)

(21) Appl. No.: 14/070,473

(22) Filed: Nov. 1, 2013

Related U.S. Application Data
(60) Provisional application No. 61/721,025, filed on Nov. 1, 2012.

(51) Int. Cl. G06F 21/31

(52) U.S. Cl. CPC G06F 21/31
USPC 726/6

(57) ABSTRACT

A relationship and sharing account system includes computing devices configured to execute modules including a user account module configured to store a plurality of user accounts, each corresponding to a user and including user information, at least some of which is accessible to other users, a login module, a communication module configured to obtain information sharing requests, which specify the sharing of information to other users, a sharing account creation module configured to create a user sharing account linked to an existing user account and corresponding to a subsidiary user, and an information duplication module configured to a) automatically copy information in a user sharing request input by the subsidiary user to the linked user account; or b) notify the user corresponding to the linked user account when an information sharing request is input by the subsidiary user and require approval before sharing the information with other users.

This application claims a benefit of priority under 35 U.S.C. §119 to Provisional Application No. 61/721,025, filed on Nov. 1, 2012, entitled “WEBSITE RELATIONSHIP AND SHARING ACCOUNT” which is fully incorporated by reference in its entirety.

### FIELD OF THE INVENTION

The invention relates generally to Internet websites and other user account-based sites and programs for sharing information or collaborating, and more particularly to user accounts on social networking sites.

### BACKGROUND OF THE INVENTION

Due to The Children's Online Privacy Protection Act of 1998, a U.S. law regulating the disclosure of personal information by persons under the age of 13, many websites do not permit persons under the age of 13 to sign up for an account. As a result, some children may create accounts by lying about their age, while others will be excluded from website content.

Other examples of people unable to use a social networking or similar website include those who are ill or physically or mentally disabled. Such persons may rely on other users to post information or updates relating to their lives. This information must be posted through the other users' accounts, and anyone wishing to receive or view this information may need to form a connection with those other users.

Needs exist for improved systems and methods for creating and managing website accounts for users under the age of 13 or who are otherwise unable to create or use their own accounts.

### SUMMARY

In some embodiments, a relationship account (which may also be referred to as a “sharing account” and which does not imply that any particular relationship must exist between users) for websites like social networks is available for users who cannot use or are not allowed to have their own account, for example persons under 13 years old and/or having disabilities (sometimes referred to as “relationship users”, “subsidiary users” or “secondary users”). A parent or other “custodian” (also referred to as a “primary user” or “custodial user”) can create the relationship account when logged into their own account, and the relationship account is then a subset of that account, separate but linked. In some embodiments, the custodian must be logged in for the relationship account to be accessed, so that the custodian controls all access to the account. In other embodiments, the relationship account has its own login (e.g. username and password) and can be accessed independently, however the custodial user may be required to approve some or all information provided by the relationship user prior to that information becoming visible to other users. In embodiments, approval may be required for some actions but not for others, and/or before some users can view the information posted, but not before others, and these settings may be determined by the custodial user. The secondary users can do their own status updates, change profile information, and take other actions normally permitted to users on the social network or other type of website, or the custodian can make such changes/posts for the secondary user. In some embodiments, certain actions require a re-authentication of the custodian to ensure the custodian is present to approve of the action being taken, or may be kept pending until approved by a custodian.

All actions in the relationship account may be duplicated in the custodial account so that the custodian can see what the secondary user is doing and so that the custodian does not have to re-enter the information/media that has been posted in his/her own account. In some embodiments, actions may also be duplicated to third-party accounts, with the permission of the custodial and/or secondary user. For example, grandparents might request that all information posted to the relationship accounts of their grandchildren be automatically copied to their accounts, so that they do not need to navigate to the parent or child's accounts to view it. Upon approval by the parent (custodian) and/or child (secondary user), this may be accomplished. When the secondary user turns 13 or otherwise becomes able to have and/or use their own account, the relationship account can be split off from the custodial account into a true account having its own login (if there was previously no separate login) and with no duplication of actions to the custodial account. Besides children, the accounts may be used for example for ill patients such as cancer patients, to document their recovery while they are too ill to update their own account, or for nursing home residents.

The accounts can also be used to encourage new members to join a site. For example, a user of a social networking site may want his or her friends or family members (or e.g. business partners/clients/employees, or fellow group members, etc.) to join as well, but they may be discouraged by the time required to create an account and set up basic profile or other information. With permission of the friends or family members (or in some embodiments, without any permissions) this user may act as custodian and create relationship accounts for them and in the process input information about them, and for example details regarding their relationships to the custodian. The custodian may then turn over these relationship accounts to the friends/family members, who may be inspired to participate by the information added by the custodian and by the ease of starting. Approval of the information in the relationship accounts may be obtained for example by sending the information to a verified email address for the friends/family members for confirmation.

In some embodiments, a company or other organizational user of a website may act as a custodial account and control relationship accounts for its employees, members, vendors or customers/clients. Depending on the nature of the website, the organizational user may have a special account that is different from other user accounts in various ways, and the related relationship accounts may be in addition to full, personal accounts for those relationship account users on the same website, and may be limited or otherwise differ from personal accounts. Such a system may maintain all communication within the organization in a secure environment while allowing for modern, social networking forms of communication and keeping all threads of a common discussion and nature combined.

In some embodiments, material posted to the relationship account may be copied to the primary/custodial user's account at that user's option. For example, an email or other communication may be sent to the primary/custodial user asking whether to copy the material to that user's account. Other possible methods of communication include pop-up windows on a device screen, SMS messages, or even phone calls or postal mail. In some embodiments, whether the primary/custodial user is given this option can be set by the primary/custodial user at the time the relationship account is established, or afterward. For example, the relationship account may be set to automatically copy all material posted by the secondary user to the primary/custodial user's account, never to copy posted material, or to copy posted material at the primary/custodial user's option on a case-by-case basis as described above.

The term “post” is used as one example of a way that information may be shared with other users in a way that it is connected to the user who shared it, and is not intended to be limiting. In traditional social networks, a user may “post” information such as text or a photo to a page dedicated to the user, and other users who are connected to that user in some way may view information posted there. Thus, the process is similar to information being “posted” to a bulletin board. In other applications, the information may be shared directly via SMS, email, etc., be broadcast via an app or social media platform such as Twitter®, or any other known means for sharing may be used, interchangeably.

In some embodiments, this setting may vary between various types of material, for example photos and videos may have one setting (e.g. automatically copied) and links and text another (e.g. custodial user given the option). If the option is given, the material may be copied to the primary/custodial user's account if a certain amount of time passes without the primary/custodial user either approving or denying the copying, or vice versa. In this way, the relationship account can be customized for the different needs of the relationship user and primary/custodial user, depending on the context of the account (e.g. whether it is used for a child or an employee, or a relative getting used to a certain site). For example, a parent may wish to post material to a child's relationship account, but may wish to post those materials or events relating to both the parent and the child only once, to the child's relationship account, and have it automatically copied also to the parent's account, since it also relates to the parent.

In some embodiments, more than one account may be linked. For example, two (or more) primary/custodial accounts may be linked to a single relationship account, or two (or more) relationship accounts may be linked to a single primary/custodial account, or two (or more) primary/custodial accounts may be linked to two or more relationship accounts. Thus, for example, a parent may serve as custodian for two children's relationship accounts, two parents may serve as custodians for a single child's relationship account, or two parents may jointly act as custodians for two children's relationship accounts. Material posted to any one account may be automatically or at the option of one or more users posted to some or all of the other linked accounts as described above in the context of a single primary/custodial and single relationship account. For example, each primary user may decide whether any given piece of material is copied automatically to their account. Copying settings may vary between the users—e.g. all materials may be copied between the relationship accounts but not between the relationship accounts and primary/custodial accounts, or vice versa. Each linked user may share or not share with each other linked user, and may have any sharing settings with regard to each other linked user, in any conceivable permutation. If there are two custodial/primary accounts for a single relationship account, either primary/custodial user can post/add material to the relationship account. If there are two relationship accounts for a single primary/custodial account, the primary/custodial user may post/add material to any of the relationship accounts.

In some embodiments, there is not necessarily a clear distinction between the primary/custodial user and the relationship account user. For example, two existing user accounts may be linked such that each user becomes the other's custodian. Because each account exists independently of the other, each user can login independently as normal and share information as desired. In such embodiments, neither user has the power to control or monitor what the other user shares. However, each user can post/share information to the linked user's account and have that information be automatically copied to the user's own account. Or in another embodiment, the user can elect for information/posts made to his or her own account to be automatically copied to the linked user's account. Thus, each user linked in that way (there may be more than two) can share information directly to two or more user accounts, including the user's own. For example, four siblings might all choose to be linked in this way. When one of the siblings shares a picture or other information containing other siblings, the information may be posted/shared directly to all the siblings' accounts or for example to the accounts of the siblings who the picture/information relates to. However, such sharing need not be limited to information pertaining to the other siblings directly.

In some embodiments, one primary user (and in such embodiments there may or may not be any secondary users) can create a sharing component within another primary user's account, rather than creating an entire separate sharing account. For example, if users share information with other users within journals containing information pertaining to a given experience, one user may create a sharing journal that posts to the accounts of a number of different users. A journal is just an example, as any information sharing component could be substituted. Changes and updates to that journal continue to post accordingly to each linked user's account. The linked users may be designated by the user who creates the shared component, and approval may be required from each designated user to establish each link. Thus for example a business that hosts a corporate event might create a journal about the event, which is a part of the autobiography of each attendee (employee). Thus the business owner may request to make this a shared journal with each attendee user. Each attendee user would receive the request and could accept or reject it.

In other embodiments, an employer, for example, might create sharing user accounts for each of its employees, even if they already have primary user accounts. Thus, each employee would have a business sharing account the employer could have control over, in addition to a personal primary user account the employer could not control. In some such embodiments, the employer's account might be the sharing account and the employee's second accounts primary user accounts. Thus the employees would have two primary user accounts, one of which the employer could automatically post information to, taking advantage of the automatic copying of posts to t he sharing account into each linked primary user account.

In embodiments of a new computer-implemented method, primary user login information is received and verified at a server and access is provided to the primary user's website account, a website relationship account creation link is displayed in the primary user's website account, a request is received at the server from within the primary user's website account to create a website relationship account, form fields are displayed for the primary user to input information relating to a subsidiary user associated with the website relationship account, information is received at the server relating to the subsidiary user, a website relationship account access link is displayed in the primary user's website account, a request is received at the server from within the primary user's website account to access the website relationship account, access is provided to the website relationship account including the information relating to the subsidiary user, further subsidiary user-related information is received at the server from within the website relationship account along with a request to display or transmit the information to a user other than the primary user, and the further subsidiary user-related information is automatically transmitted to the primary user for viewing. In certain website systems, all comments posted in a relationship account may also be automatically posted to the primary account in the appropriate category/area as a shared experience, memory, observation, etc. as appropriate, for viewing as normal for the primary user's shared information.

For example, a user may navigate to a social networking website in an Internet browser, enter a username and password into a field on the website, and click “login” or a similar button or other link to submit the login information to a website server. The website server receives the login information and verifies it against a database of user login information, allowing the user to access its account and transmitting information pertaining to the user's profile and/or other users' information or general site information (e.g. home page information) to the user's computing device for display. Included in that information is a button or other link for creating a relationship account linked to the currently logged-in account.

The user selects that button or other link to transmit to the website server a request to create a relationship account. The server transmits further information for display on the user's device, which includes a form or other mechanism for inputting information for the new relationship account. This information may include the relationship account user's name and email address and other profile information. The user inputs such information and clicks a button or other link (e.g. “submit” button) to transmit the information to the server, where it is received. The server then enters the received information into a database and creates a link for accessing the relationship account within the information displayed to the user when the user logs into the user's account.

The user (or someone else using the user's device after the user has logged in) selects the link to access the relationship account and the server transmits related information for display on the user's device, for example a relationship account home page containing a relationship account user's profile information such as picture, name, recent updates, etc. The user or other person enters information into the browser in an input area displayed as part of the website, for example the user may select or navigate to an update input box and type or otherwise input information relating to the user's current activity, and then presses “submit” or a similar button to transmit the information to the server. The server receives that information and transmits the information to another user or makes it available for other users to view, and automatically notifies the user (who created the relationship account) that the information was submitted and/or who it was shared with or where and to whom it was displayed. This notification may be to a private area of the user's account, directly to an email address, etc. The information may also be copied to a section of the user's profile so that viewers of the user's profile page can see it. The example above is merely for illustrative purposes and should not be considered limiting.

In embodiments of a new computer-implemented method, a request is received at the server from within a primary user's website account to create a website relationship account, information is received at the server relating to a subsidiary user associated with the website relationship account, a request is received at the server from within the primary user's website account to access the website relationship account, access is provided to the website relationship account including the information relating to the subsidiary user, further subsidiary user-related information is received at the server from within the website relationship account along with a request to display or transmit the information to a user other than the primary user, and the further subsidiary user-related information is automatically transmitted to the primary user for viewing.

In embodiments of a new computer-implemented method, primary user login information is received and verified at a server and access is provided to the primary user's website account, a website relationship account creation link is displayed in the primary user's website account, a request is received at the server from within the primary user's website account to create a website relationship account, form fields are displayed for the primary user to input information relating to a subsidiary user associated with the website relationship account, information is received at the server relating to the subsidiary user, a website relationship account access link is displayed in the primary user's website account, and links for transmitting or displaying input information to other users are displayed in the subsidiary user's website account. The subsidiary user's website account links are configured to automatically transmit the input information to the primary user regardless of the intended recipient or viewer.

In embodiments of a new computer-implemented method, a request is received at a server from within a primary user's website account to access a website relationship account, access is provided to the website relationship account including the information relating to a subsidiary user, further subsidiary user-related information is received at the server from within the website relationship account, along with a request to display or transmit the information to a user other than the primary user, and the further subsidiary user-related information is automatically transmitted to the primary user for viewing.

A new system in embodiments includes a processor and a memory containing a program, which, when executed by the processor, is configured to perform an operation. The operation includes receiving and verifying primary user login information and providing access to the primary user's website account, displaying in the primary user's website account a website relationship account creation link, receiving a request from within the primary user's website account to create a website relationship account, displaying form fields for the primary user to input information relating to a subsidiary user associated with the website relationship account, receiving information relating to the subsidiary user, displaying in the primary user's website account a website relationship account access link, receiving a request from within the primary user's website account to access the website relationship account, providing access to the website relationship account including the information relating to the subsidiary user, receiving further subsidiary user-related information from within the website relationship account along with a request to display or transmit the information to a user other than the primary user, and automatically transmitting the further subsidiary user-related information to the primary user for viewing.

A computer-readable storage medium in embodiments includes a program, which when executed on a processor performs an operation. The operation includes receiving and verifying primary user login information and providing access to the primary user's website account, displaying in the primary user's website account a website relationship account creation link, receiving a request from within the primary user's website account to create a website relationship account, displaying form fields for the primary user to input information relating to a subsidiary user associated with the website relationship account, receiving information relating to the subsidiary user, displaying in the primary user's website account a website relationship account access link, receiving a request from within the primary user's website account to access the website relationship account, providing access to the website relationship account including the information relating to the subsidiary user, receiving further subsidiary user-related information from within the website relationship account along with a request to display or transmit the information to a user other than the primary user, and automatically transmitting the further subsidiary user-related information to the primary user for viewing.

In embodiments of a new computer-implemented method, primary user login information is input and transmitted and the primary user's website account is accessed, an option within the primary user's website account to create a website relationship account is selected, information relating to a subsidiary user is input and transmitted, an option within the primary user's website account to access the website relationship account is selected, further subsidiary user-related information is input and transmitted with a request to display or transmit the information for a user other than the primary user, and the further subsidiary user-related information is automatically transmitted to the primary user for viewing.

A new system, in embodiments, includes a server and a plurality of user accounts stored in a database on the server, where each user account includes user information. The server is configured to verify user login information and allow a user to access a corresponding user account, create a user relationship account linked to an existing user account, permit access to the user relationship account only by a user allowed to access the linked existing user account, and transmit changes to the user relationship account user information to the user corresponding to the linked existing user account.

These and further and other objects and features of the invention are apparent in the disclosure, which includes the above and ongoing written specification, with the drawings.

### BRIEF DESCRIPTION OF THE DRAWINGS

The invention will be more particularly described in conjunction with the following drawings wherein:

FIG. 1 is a flowchart illustrating a relationship account method, in an embodiment.

FIG. 2 is a flowchart illustrating a relationship account method, in an embodiment.

FIG. 3 is a computing environment diagram illustrating a relationship account system, in an embodiment.

FIG. 4 is a second computing environment diagram illustrating a relationship account system, in an embodiment.

FIG. 5 is a third computing environment diagram illustrating a relationship account system, in an embodiment.

### DETAILED DESCRIPTION

New website relationship account and sharing systems and methods will now be disclosed in terms of various exemplary embodiments. This specification discloses one or more embodiments that incorporate features of the invention. The embodiment(s) described, and references in the specification to “some embodiments”, “one embodiment”, “an embodiment”, “an example embodiment”, etc., indicate that the embodiment(s) described may include a particular feature, structure, or characteristic. Such phrases are not necessarily referring to the same embodiment(s). When a particular feature, structure, or characteristic is described in connection with an embodiment, persons skilled in the art may effect such feature, structure, or characteristic in connection with other embodiments whether or not explicitly described.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Illustrative embodiments of the invention are described below. In the interest of clarity, not all features of an actual implementation are described in this specification. It will of course be appreciated that in the development of any such actual embodiment, numerous implementation-specific decisions may be made to achieve the developers' specific goals, such as compliance with system-related and business-related constraints, which may vary from one implementation to another. Moreover, it will be appreciated that such a development effort might be complex and time-consuming, but may nevertheless be a routine undertaking for those of ordinary skill in the art having the benefit of this disclosure.

Embodiments of the present invention will now be described with reference to the attached figures. Various structures, connections, systems and devices are schematically depicted in the drawings for purposes of explanation only and so as to not obscure the disclosed subject matter with details that are well known to those skilled in the art. Nevertheless, the attached drawings are included to describe and explain illustrative examples of the present invention.

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

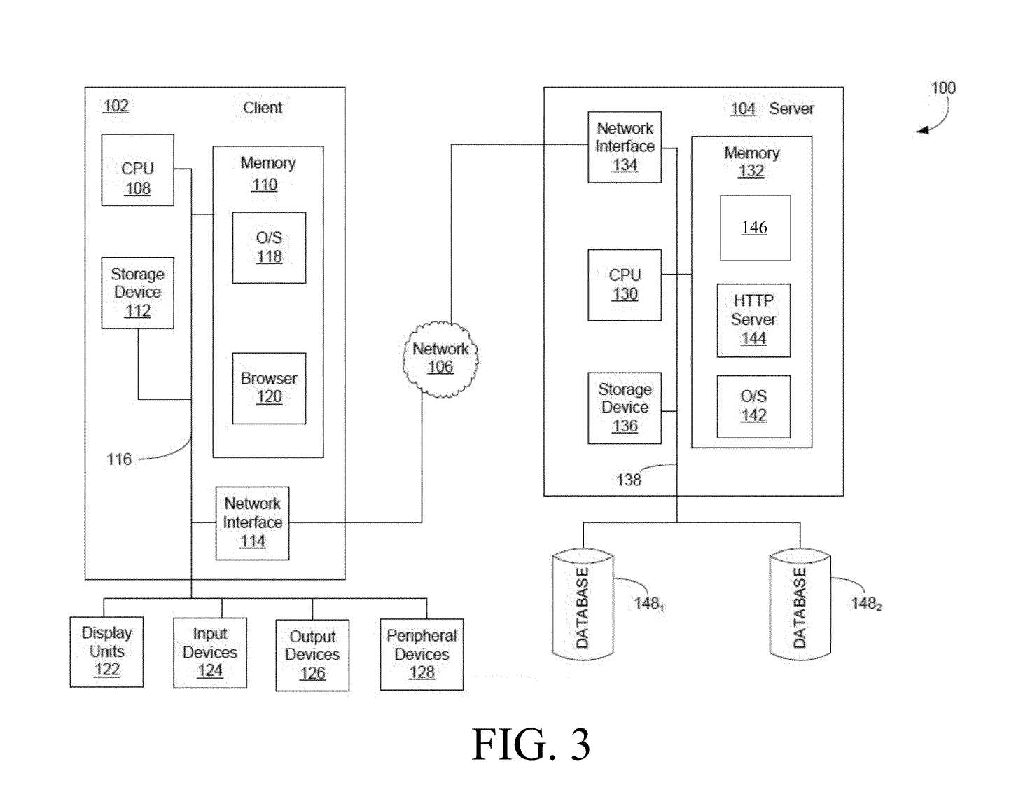

One embodiment of the invention is implemented as a program product for use with a computer system such as, for example, the computing environment 100 shown in FIG. 3 and described below. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM/DVD disks readable by a CD-ROM/DVD drive); (ii) alterable information stored on writable storage media (e.g., floppy disks within a diskette drive or hard-disk drive, solid state storage devices, USB drives); and (iii) information conveyed to a computer by a communications medium, such as through a computer or telephone network or cable provider network, including wireless communications. The latter embodiment specifically includes information downloaded from the Internet and/or other networks, including information distributed in the cloud. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices.

In addition, various programs described hereinafter may be identified based upon the application for which they are implemented in one or more specific embodiments of the invention. However, it should be appreciated that any particular program nomenclature that follows is used merely for convenience, and thus the invention should not be limited to use solely in any specific application identified and/or implied by such nomenclature. In this regard, references to particular definitional languages, such as HTML and XML, are illustrative in nature and do not serve to limit the claims. It is broadly contemplated that the invention is applicable regardless of the particular schema and/or language used to define network resource content.

Systems, and methods for creating and operating website relationship and sharing accounts for children under 13 years of age, those unable to create or use a website account or not allowed to do so, and others are described herein.

Turning now to FIG. 3, a block diagram illustrating an exemplary computing environment 100, in accordance with an embodiment of the present invention, is shown. In general, the computing environment 100 includes a client (e.g., a user's) computer 102, and a server computer 104. The client computer 102 and the server computer 104 may be components of the same computer system or may be connected via a network 106, such as the Internet. As shown, the client computer 102 includes a central processing unit (CPU) 108 or motherboard connected to a memory 110, a storage device 112, and a network interface 114 via a bus 116. The CPU 108 is included to be representative of a single CPU, multiple CPUs, a single CPU having multiple processing cores, and the like. The storage device 112 stores application programs and data for use by the client computer 102. Examples of the storage device 112 include one or more hard-disk drives, flash memory devices, optical media and the like. The client computer 102 may be connected to the data communications network 106 (e.g., a local area network, which itself may be connected to other networks such as the internet) using the network interface 114. The memory 110 can be one or a combination of memory devices, including random access memory, nonvolatile or backup memory (e.g., programmable or flash memories, read-only memories, etc.). Illustratively, the memory 110 of client computer 102 stores an operating system 118 used to manage hardware and software executing on the client computer 102. As shown, memory 110 also includes a browser program 120 which, when executed by CPU 108, provides support for navigating between various servers and locating network addresses at one or more of servers (e.g., server computer 104).

The client computer 102 may be connected to one or more display units 122, input devices 124, output devices 126 and peripheral devices 128. The display units 122 may be internal or external monitors, television screens, handheld device displays, and the like. The input devices 124 may be any one of a keyboard, mouse, track-ball, stylus, mouse pad, mouse button, joystick, scanner or the like. The output devices 126 may be any one of a monitor, printer, plotter, copier or other output device. The peripheral devices 128 may be any other device which can be coupled to a computer: a CD/DVD drive capable of reading and/or writing to physical digital media, a USB device, Zip Drive, external floppy drive, external hard drive, phone and/or broadband modem, router/gateway, access point and/or the like.

Similar to the client computer 102, the server computer 104 may include a CPU 130, a memory 132, a network interface device 134, and a storage device 136, coupled via a bus 138. In embodiments, one or more of these elements may be distributed in the cloud. The memory 132 may be a random access memory sufficiently large to hold the necessary programming and data structures that are located on the server computer 104. As shown, the memory 132 stores an operating system 140 used to manage server hardware and software executing on the server computer 102. Illustratively, the memory 132 also includes a hypertext transfer protocol (http) server 144 configured to service requests from the client computer 102. For example, the http server 144 may respond to requests for access to electronic resources (e.g., HTML documents, network information, and the like) residing on the server computer 104. However, one of ordinary skill in the art will recognize that the http server 144 is merely illustrative and embodiments of the invention may be adapted to support both known and unknown protocols. The programming and data structures of the http server 144 may be accessed and executed by the CPU 130 as needed during operation. The server computer 104 may connect to the network 106 using the network interface device 134 (e.g., an analog modem, a wired network card, or a wireless network device).

In one embodiment, users may interact with the server computer 104 using a graphical user interface (GUI). In a particular embodiment, GUI content may comprise HTML documents (i.e., web pages) rendered on the display unit 122 coupled with the client computer 102 using the browser 120. In one embodiment, the web pages may include pages that allow a user to share information with other users and/or view information shared by other users over a social network.

The memory 132 may therefore include a relationship account management module 146. In other embodiments, this module may be subsumed within a larger program, module, or software, for example for operation of a website such as a social networking website, or within the HTTP (or e.g. HTTPS) server. The relationship account management module may comprise a software application configured to provide the ability (e.g., via the GUI) for a user to create and use a website relationship account linked to a custodial account, which can only be accessed through the custodial account and keeps a custodian informed of actions taken in the relationship account and has the ability to copy relationship account updates to the custodial account. The server computer 104 may be coupled to one or more databases 148₁, 148₂ which may include a relational database 148₁ that is queried using an SQL query, or an XML database 148₂ queried using an XML query. Other database types may be used in various embodiments. Databases 148₁, 148₂ may store account profile information, including updates. Account information that is copied from a relationship account to a custodial account and displayed in both places may be stored in a single place in the databases. If the accounts are split, a copy of the information may be made in the databases, so that the information can be deleted from one account without affecting its presence in the other account. Alternatively, after a split the information may not be copied and any deletion may be handled in another way (for example by deleting a piece of code indicating that the stored information should be displayed on an account). After splitting, one user may wish to add some comment or further detail, etc., regarding the shared material. Such additions may automatically be copied between the accounts even though the accounts are no longer linked, or may not be, or the copying may be at the user's option as described earlier. The invention, however, is not limited to any particular physical database storage mechanism and may readily be extended to operate on other such mechanisms, whether currently known or unknown. While the databases 148₁, 148₂ are illustrated as being external to the server system, it is noted that the databases 148₁, 148₂ may exist on a local storage device (e.g., storage device 136) of the server computer 104, or may be accessed over the network 106. In some embodiments, the databases may be used to store user account information to allow a user to log in to a social networking or other website and to store user profile information for sharing with other users.

It will be understood for purposes of this disclosure that a module is one or more computer processes, computing devices or both, configured to perform one or more functions. A module may present one or more interfaces which can be utilized to access these functions. Such interfaces include APIs, web services interfaces presented for a web services, remote procedure calls, remote method invocation, etc.

It should be appreciated that although modules may be illustrated as being implemented within a single processing unit, in implementations in which multiple processing units are used, one or more of the modules may be implemented remotely from the other modules. The description of the functionality provided by the different modules is for illustrative purposes, and is not intended to be limiting, as any of the modules may provide more or less functionality than is described. For example, one or more of modules may be eliminated, and some or all of its functionality may be provided by the other modules. As another example, a processor may be configured to execute one or more additional modules that may perform some or all of the functionality attributed to one of the modules described below.

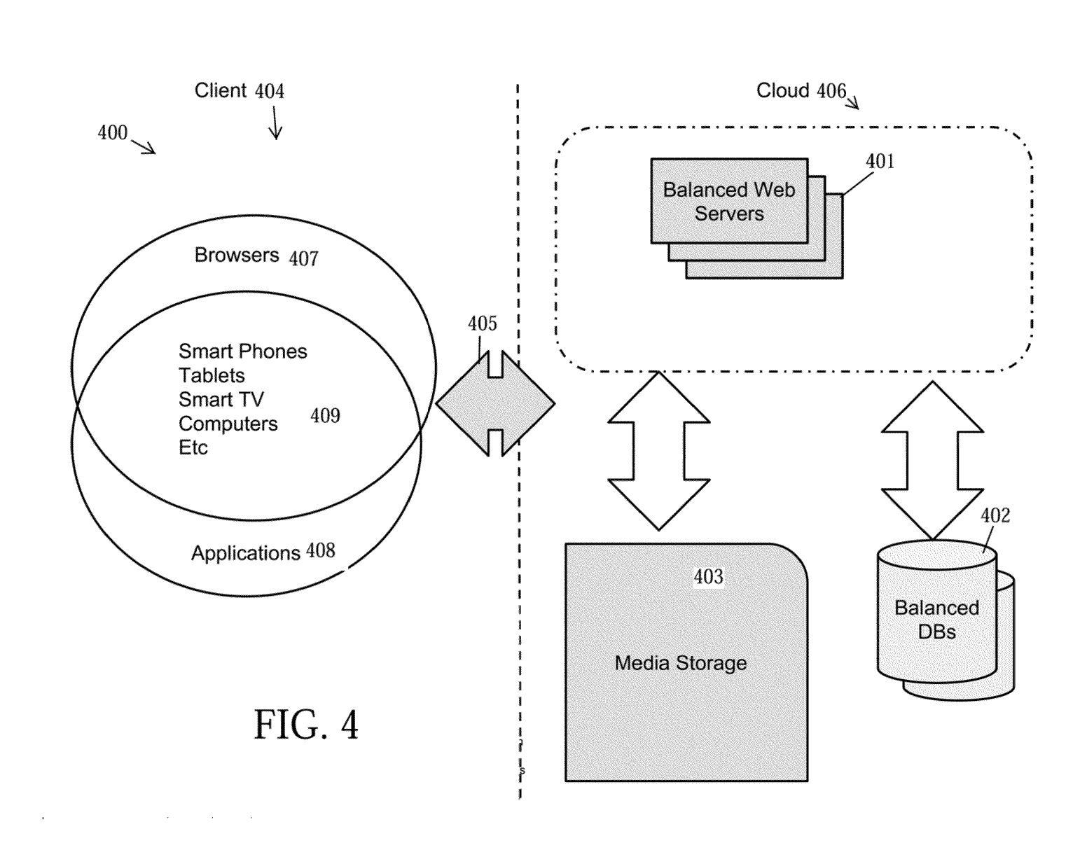

Turning now to FIG. 4, a block diagram illustrating an exemplary computing environment 400, in accordance with an embodiment of the present invention, is shown. In the computing environment 400, a client 404 interacts via Internet protocols with a relationship/sharing account system in the cloud 406. In cloud 406 are balanced web servers 401, which are responsible for the in/out transfer of data from the client 404 to the cloud 406 and from the cloud 406 to the client 404. It comprises the control (logic), model (data architecture) and view (HTML view). Also in the cloud 406 are balanced databases 402, which are responsible for storing content data, e.g. user profiles, relations among users, etc., and media storage 403, which is responsible for storing media objects such as videos, audios, pictures, documents, etc. Client 404 can connect with the cloud 406 through a browser 407 and/or application 408 on user device 409. In any case, these interact with TCP/IP family protocols 405 such as HTTP, HTTPS, SMTP, etc., which support the interchange of data between the clients 404 and the cloud 406. The difference between browsers 407 and applications 408 is that users access services through browsers 407 on platforms such as Chrome®, Mozilla®, Safari®, and/or any kind of native browser from the user's device (e.g. SmartPhone, Tablet, Computer, Smart TV, etc.). Applications 408 are created with native code on each platform, for example an iPhone® app, a Smart TV app, etc.

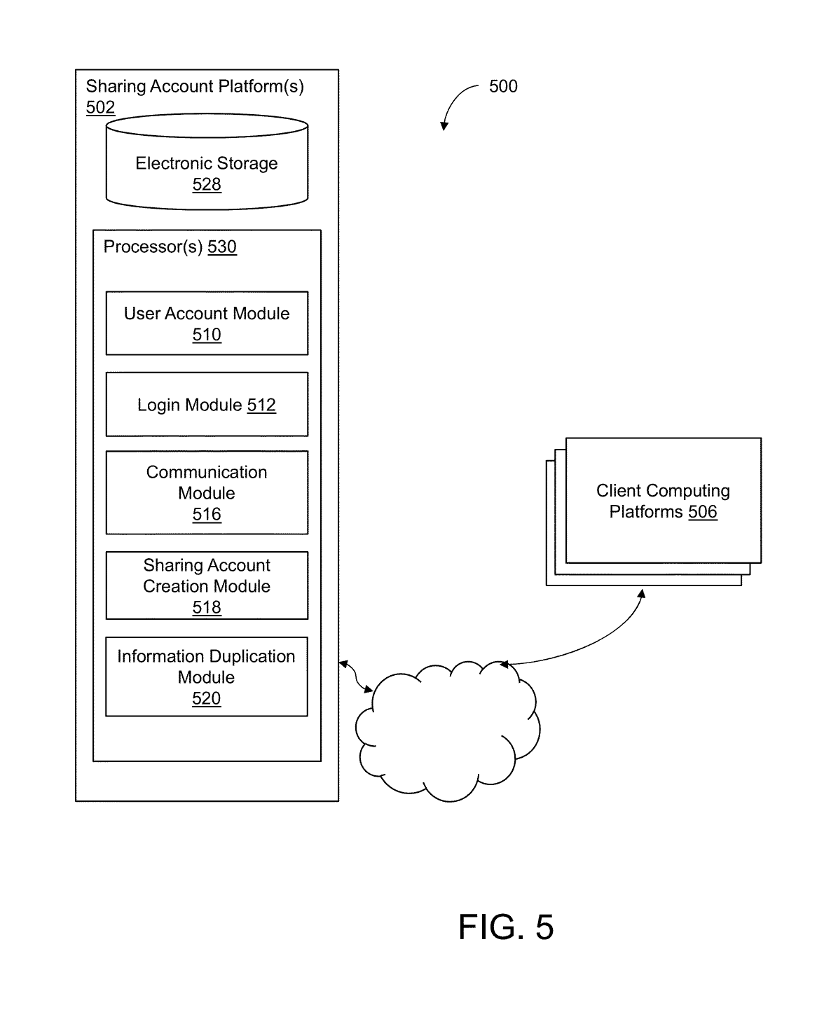

FIG. 5 illustrates system 500 configured to provide website relationship/sharing accounts, in an embodiment. Providing the relationship/sharing accounts may include hosting a website over a network. Sharing account platform 502 may be configured to communicate with one or more client computing platforms 506 according to a client/server architecture. The users may access system 500 via client computing platforms 506.

System 500 is only one example of a suitable computing environment and is not intended to suggest any limitation as to the scope of use or functionality of the features described herein. The sharing account platform 502 is configured to host one or more social networks or other websites and execute one or more computer program modules. In implementations, sharing account platform 502 may be configured to receive user requests to provide access to a plurality of online communities to users. The computer program modules may include one or more of a user account module 510, a login module 512, a communication module 516, a sharing account creation module 518, and an information duplication module 520. As noted, the client computing platform(s) 506 may include one or more computer program modules that are the same as or similar to the computer program modules of the sharing account platform(s) 502 to facilitate providing the sharing account to the user.

User account module 510 may be configured to store a plurality of user accounts, each user account corresponding to a user and comprising user information, at least some of which is accessible to other users. Login module 512 may be configured to log user devices into user accounts. Communication module 514 may be configured to obtain information sharing requests input by users, wherein information sharing requests specify the sharing of information to other users through one or more of the user accounts. Sharing account creation module 518 may be configured to create a user sharing account linked to an existing user account and corresponding to a subsidiary user. Information Duplication module 520 may be configured to a) automatically copy information shared in a user sharing request input via the user sharing account to the linked existing user account; or b) notify the user corresponding to the linked existing user account when an information sharing request is input via the user sharing account and require the user's approval before sharing the information with other users.

In some implementations, the sharing account platform 502 and client computing platforms 506 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which servers 502 and client computing platforms 506 may be operatively linked via some other communication media.

A given client computing platform 506 may include one or more processors configured to execute computer program modules. The computer program modules may be configured to enable an expert or user associated with the given client computing platform 506 to interface with system 500, and/or provide other functionality attributed herein to client computing platforms 506. By way of non-limiting example, the given client computing platform 506 may include one or more of a desktop computer, a laptop computer, a handheld computer, a tablet computing platform, a NetBook, a Smartphone, a gaming console, and/or other computing platforms.

Sharing account platform 502 may include electronic storage 528, one or more processors 530, and/or other components. Sharing account platform 502 may include communication lines, or ports to enable the exchange of information with a network and/or other computing platforms. Illustration of sharing account platform 502 in FIG. 5 is not intended to be limiting. Sharing account platform 502 may include a plurality of hardware, software, and/or firmware components operating together to provide the functionality attributed herein to sharing account platform 502. For example, sharing account platform 502 may be implemented by a cloud of computing platforms operating together as sharing account platform 502.

Electronic storage 528 may comprise non-transitory storage media that electronically stores information. The electronic storage media of electronic storage 528 may include one or both of system storage that is provided integrally (i.e., substantially non-removable) with sharing account platform 502 and/or removable storage that is removably connectable to sharing account platform 502 via, for example, a port (e.g., a USB port, a firewire port, etc.) or a drive (e.g., a disk drive, etc.). Electronic storage 528 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 528 may include one or more virtual storage resources (e.g., cloud storage, a virtual private network, and/or other virtual storage resources). Electronic storage 528 may store software algorithms, information determined by processor 530, information received from sharing account platform 502, information received from client computing platforms 506, and/or other information that enables sharing account platform 502 to function as described herein.

Processor(s) 530 is configured to provide information processing capabilities in sharing account platform 502. As such, processor 530 may include one or more of a digital processor, an analog processor, a digital circuit designed to process information, an analog circuit designed to process information, a state machine, and/or other mechanisms for electronically processing information. Although processor 530 is shown in FIG. 5 as a single entity, this is for illustrative purposes only. In some implementations, processor 530 may include a plurality of processing units. These processing units may be physically located within the same device, or processor 530 may represent processing functionality of a plurality of devices operating in coordination. The processor 530 may be configured to execute modules 510, 512, 516, 518, and 520. Processor 530 may be configured to execute modules 510, 512, 516, 518, and 520 by software; hardware; firmware; some combination of software, hardware, and/or firmware; and/or other mechanisms for configuring processing capabilities on processor 530. As used herein, the term “module” may refer to any component or set of components that perform the functionality attributed to the module. This may include one or more physical processors during execution of processor readable instructions, the processor readable instructions, circuitry, hardware, storage media, or any other components.

The operations of the methods presented below are intended to be illustrative. In some embodiments, the methods may be accomplished with one or more additional operations not described, and/or without one or more of the operations discussed. Additionally, the order in which the operations of the illustrated methods are shown and described below is not intended to be limiting.

In some embodiments, the methods may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of the methods in response to instructions stored electronically on an electronic storage medium. The one or more processing devices may include one or more devices configured through hardware, firmware, and/or software to be specifically designed for execution of one or more of the operations of the methods.

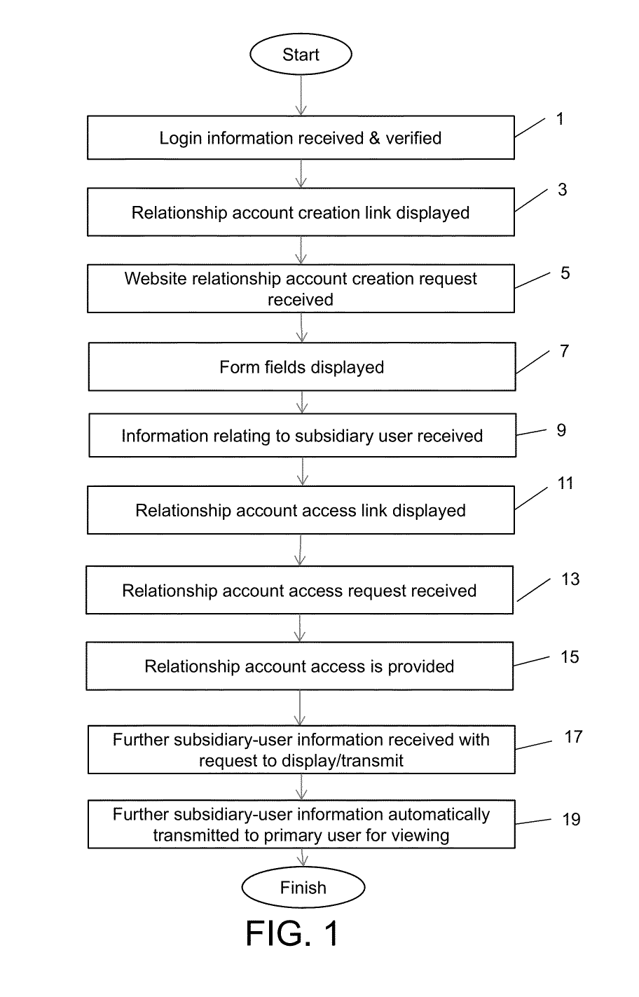

FIG. 1 is a flowchart illustrating a relationship account method, in an embodiment. Primary user login information is received and verified at a server and access is provided to the primary user's website account 1, a website relationship account creation link is displayed 3 in the primary user's website account, a request is received 5 at the server from within the primary user's website account to create a website relationship account, form fields are displayed 7 for the primary user to input information relating to a subsidiary user associated with the website relationship account, information is received 9 at the server relating to the subsidiary user, a website relationship account access link is displayed 11 in the primary user's website account, a request is received 13 at the server from within the primary user's website account to access the website relationship account, access is provided 15 to the website relationship account including the information relating to the subsidiary user, further subsidiary user-related information is received 17 at the server from within the website relationship account along with a request to display or transmit the information to a user other than the primary user, and the further subsidiary user-related information is automatically transmitted to the primary user for viewing 19.

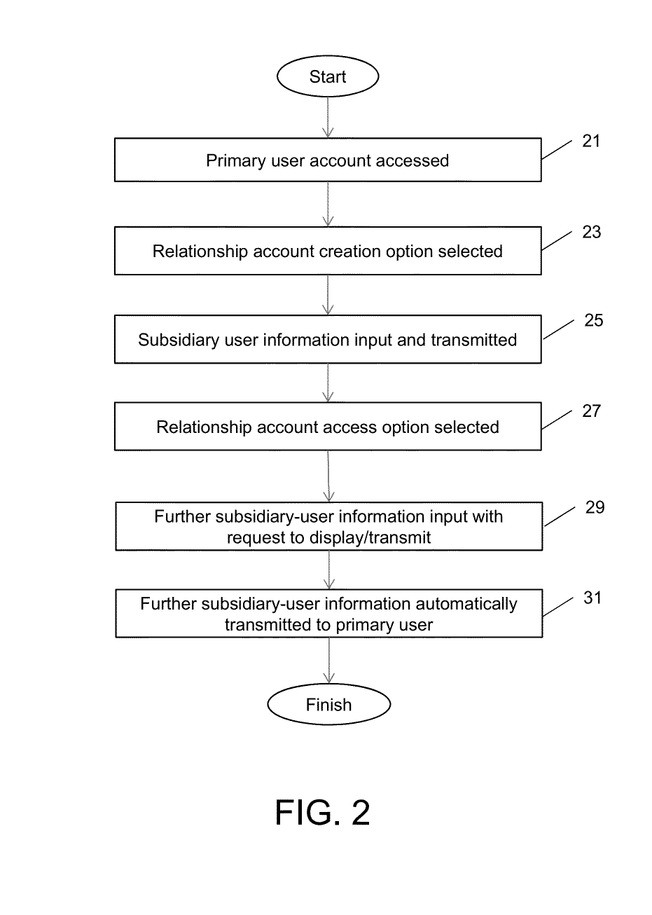

FIG. 2 is a flowchart illustrating a relationship account method, in an embodiment. Primary user login information is input and transmitted and the primary user's website account is accessed 21, an option within the primary user's website account to create a website relationship account is selected 23, information relating to a subsidiary user is input and transmitted 25, an option within the primary user's website account to access the website relationship account is selected 27, further subsidiary user-related information is input and transmitted 29 with a request to display or transmit the information for a user other than the primary user, and the further subsidiary user-related information is automatically transmitted 31 to the primary user for viewing.

In another method, a plurality of user accounts are stored, each user account corresponding to a user and comprising user information, at least some of which is accessible to other users. This step may be performed by a user account module the same as or similar to user account module 510, in accordance with one or more implementations. User devices are logged into user accounts. This step may be performed by a login module the same as or similar login module 512, in accordance with one or more implementations. Information sharing requests input by users are obtained, where the information sharing requests specify the sharing of information to other users through one or more of the user accounts. This step may be performed by a communication module the same as or similar to communication module 514, in accordance with one or more implementations. A user sharing account linked to an existing user account and corresponding to a subsidiary user is created. This step may be performed by a sharing account creation module the same as or similar to sharing account creation module 516, in accordance with one or more implementations. Information shared in a user sharing request input via the user sharing account is automatically copied to the linked existing user account or the user corresponding to the linked existing user account is notified when an information sharing request is input via the user sharing account and the user's approval is required before sharing the information with other users. This step may be performed by an information duplication module the same as or similar to information duplication module 520, in accordance with one or more implementations.

The invention is not limited to the particular embodiments illustrated in the drawings and described above in detail. Those skilled in the art will recognize that other arrangements could be devised, for example, using various computing environments and types of websites and accounts. The invention encompasses every possible combination of the various features of each embodiment disclosed. One or more of the elements described herein with respect to various embodiments can be implemented in a more separated or integrated manner than explicitly described, or even removed or rendered as inoperable in certain cases, as is useful in accordance with a particular application. While the invention has been described with reference to specific embodiments, modifications and variations of the invention may be constructed without departing from the scope of the invention.

I claim:

1. A sharing account system, comprising:
a server; and
a plurality of user accounts stored on the server, each user account corresponding to a user and comprising user information;
wherein the server is configured to:
verify user login information and allow a user to access a corresponding user account;
create a user sharing account linked to an existing primary user account corresponding to a primary user; and at least one of the following:
a) permit access to the user sharing account only by the primary user;
b) automatically copy changes to user information of the user sharing account to the linked primary user account; and
c) transmit changes to user information of the user sharing account to the primary user and requiring primary user approval before permitting other users to view the changes.

2. The system of claim 1, wherein the server is further configured to split the user sharing account from the primary user account so that access to the user sharing account requires different login information than accessing the primary user account and changes to user information of the user sharing account are not copied to the primary user account or transmitted to the primary user for approval.

3. The system of claim 1, wherein the server is further configured to copy changes to user information of the user sharing account to a third party user account upon receiving a request from the third party user account and approval from the primary user and/or the user corresponding to the user sharing account.

4. The system of claim 1, wherein the server is configured to copy changes to user information of the user sharing account to the linked primary user account.

5. The system of claim 1, wherein the user information comprises text or other media submitted by the corresponding user.

6. The system of claim 1, wherein the server is further configured to link the created user sharing account to one or more additional existing primary user accounts.

7. The system of claim 1, wherein the server is further configured to create one or more additional user sharing accounts linked to the existing primary user account.

8. The system of claim 7, wherein the server is further configured to copy changes to user information of the user sharing account to the one or more additional user sharing accounts.

9. The system of claim 1, wherein the server is further configured to create one or more additional user sharing accounts linked to the existing primary user account and to link the created user sharing accounts to one or more additional existing primary user accounts.

10. The system of claim 1, wherein transmitting changes to the user sharing account user information to the primary user comprises at least one of sending an email, sending an SMS message, sending an account message, and activating a pop-up window on the primary user's computing device.

11. The system of claim 1, wherein the server is configured to prevent display of changes to user information of the user sharing account to other users until approval is received from the primary user.

12. The system of claim 1, wherein the server is further configured to manage user information changes transmission settings, wherein the settings control which changes are transmitted or how changes are transmitted.

13. The system of claim 12, wherein the settings dictate that certain types of user information changes are copied and/or transmitted and others are not.

14. The system of claim 12, wherein the settings are received from the primary user.

15. The system of claim 12, wherein the settings determine whether changes to user information of the user sharing account are automatically reversed or approved for viewing by other users if the primary user does not indicate approval or disapproval within a set period of time.

16. The system of claim 12, wherein the user sharing account is linked to a plurality of existing primary user accounts, or a plurality of user sharing accounts are linked to a single existing primary user account, or a plurality of user sharing accounts are linked to a plurality of existing primary user accounts, wherein separate settings control transmission of changes between each pair of linked users.

17. A computer-implemented method for relationship and sharing accounts, the method being implemented in a server, the method comprising:
verifying user login information and allow a user to access a corresponding user account;
creating a user sharing account linked to an existing primary user account corresponding to a primary user; and
at least one of the following:
a) permitting access to the user sharing account only by the primary user;
b) copying changes to user information of the user sharing account to the linked primary user account; and
c) transmitting changes to user information of the user sharing account to the primary user and requiring primary user approval before permitting other users to view the changes.

18. The method of claim 17, further comprising splitting the user sharing account from the existing user account so that access to the user sharing account requires different login information than accessing the existing user account and changes to user information of the user sharing account are not copied to the linked primary user account or transmitted to the primary user for approval.

19. The method of claim 17, further comprising linking the user sharing account to a plurality of existing primary user accounts, or linking a plurality of user sharing accounts to a single existing primary user account, or linking a plurality of user sharing accounts to a plurality of existing primary user accounts.

20. A relationship and sharing account system, the system comprising:
one or more computing devices configured to execute modules, the modules comprising:
a user account module configured to store a plurality of user accounts, each user account corresponding to a user and comprising user information, at least some of which is accessible to other users;
a login module configured to log user devices into user accounts;
a communication module configured to obtain information sharing requests input by users, wherein information sharing requests specify the sharing of information to other users through one or more of the user accounts;
a sharing account creation module configured to create a user sharing account linked to an existing user account and corresponding to a subsidiary user; and
an information duplication module configured to a) automatically copy information shared in a user sharing request input via the user sharing account to the linked existing user account; or b) notify the user corresponding to the linked existing user account when an information sharing request is input via the user sharing account and require the user's approval before sharing the information with other users.
